(19) United States
(12) Patent Application Publication
(10) Pub. No.: US 2024/0355202 A1
(43) Pub. Date: Oct. 24, 2024

(54) VEHICLE TRAVEL CONTROL SYSTEM, SERVER DEVICE USED THEREBY, AND VEHICLE

(71) Applicant: SUBARU CORPORATION, Tokyo (JP)

(72) Inventors: Hajime OYAMA, Shibuya-ku, Tokyo (JP); Masato MIZOGUCHI, Shibuya-ku, Tokyo (JP); Norikazu EBISAWA, Minato-ku, Tokyo (JP); Kengo KOBAYASHI, Minato-ku Tokyo (JP); Hiroaki KAWAMURA, Minato-ku, Tokyo (JP); Masaru NAKANISHI, Minato-ku Tokyo (JP)

(21) Appl. No.: 18/269,923

(22) PCT Filed: Dec. 24, 2021
(86) PCT No.: PCT/JP2021/048278

§ 371 Date: Jun. 27, 2023

(30) Foreign Application Priority Data
Dec. 28, 2020 (JP) 2020-218969

(51) Int. Cl. G08G 1/0967; G08G 1/01

(52) U.S. Cl. CPC G08G 1/096725; G08G 1/0108; G08G 1/0145

(57) ABSTRACT

A travelling control system includes vehicles each with a controller configured to execute travelling control, a server including a generator configured to generate travelling control information, and a determiner configured to determine priority with respect to the vehicles including a first vehicle. In a case that the determiner has determined to give priority to the first vehicle, the generator of the server generates the travelling control information for each of the vehicles such that a travelling of the first vehicle has priority over a travelling of other vehicle, even in a case that the first vehicle has lower priority, based on the priority rule in traffic. The determiner is configured to determine to temporarily give priority to the first vehicle in a case that there is a request from the first vehicle stopped for performing traffic-jam-cutting-in.

### TECHNICAL FIELD

The present invention relates to a travelling control system for vehicles, a server used for the travelling control system, and a vehicle.

### BACKGROUND

The control system provided in a vehicle of Patent Literature 1 sends, between vehicles, a plan about a non-travelling area defined as an area in which an automatically driven vehicle does not travel.

Patent Literature 2 discloses an inter vehicle communication system in which moving vehicles communicate with each other. Patent Literature 2 discloses performing the following in a case that a lane change is performed. That is, specifying a following and straight travelling automobile (vehicle) on a lane into which the lane change is performed by sensor means mounted on an own automobile (own vehicle); sending information requesting the lane change to the following and straight travelling automobile by using an identification number of the following and straight travelling automobile according to a unicast system; and perform the lane change by a control of a travelling of the own automobile after an onboard communication device has received a reply of which contents indicates acceptance of the lane change from the following and straight travelling automobile according to the unicast system.

In those techniques, each vehicle notifies contents of autonomous travelling control to other vehicle in the surroundings. Thus, it is considered that effect of some degree is obtained regarding avoidance or suppression of a collision.

### CITATION LIST

### Patent Literature

Patent Literature 1: International Publication No. 2018/179237
Patent Literature 2: International Publication No. 2016/147622

### SUMMARY

### Technical Problem

However, it is difficult to say that travelling of each vehicle executing travelling control of an automatic driving or of a driving support (driving assist) becomes appropriate travelling merely by each vehicle autonomously executing the travelling control and notifying it to other vehicle in the surroundings.

For example, although a line-of-sight communication such as a V2V communication etc. is used in the notification to the other vehicle in the surroundings, an environment in which suitable line-of-sight communication is not possible may be expected to occur in real world road environment.

Further, even in a case that the plurality of vehicles autonomously executes the travelling control, it is considered that their smooth travelling based on priority basically following the priority rule in traffic is desirable. If the travelling decided by the notification to other vehicle in the surroundings and based on priority not following the priority rule in traffic is executed as a normal condition, it is considered that an occupant will feel discomfort and/or anxiety about such travelling of the vehicle.

Thus, regarding the travelling control of the vehicle, it is difficult to say that the travelling control simply capable of avoiding or suppressing a collision is sufficient travelling control. It is required that safety and a sense of security about the travelling of the vehicle can be obtained by the traveling control.

### Solution to Problem

A travelling control system for vehicles according to an aspect of a present invention includes:
a plurality of vehicles each including a controller configured to execute travelling control of an automatic driving or of a driving support in a case that the plurality of vehicles travels on a road;
a server including a generator configured to generate travelling control information for the plurality of vehicles such that the plurality of vehicles travels based on priority following a priority rule in traffic; and
a determiner configured to determine priority with respect to the plurality of vehicles including a first vehicle intending to travel on the road, wherein:
the travelling control system is configured to send the travelling control information generated by the generator of the server to at least one of the plurality of vehicles so as to cause the controller of the at least one of the plurality of vehicles to execute the travelling control using the travelling control information; and
in a case that the determiner has determined to give priority to the first vehicle, the generator of the server is configured to generate the travelling control information for the plurality of vehicles such that a travelling of the first vehicle has priority over a travelling of other vehicle, of the plurality of vehicles, even in a case that the first vehicle has lower priority, based on the priority rule in traffic, compared to the other vehicle.

Suitably, the determiner is configured to determine to temporarily give priority to the first vehicle in a case that:
the first vehicle is stopped at a position, on a first road, before a second road in which a traffic jam exists, the first road extending to a place where the first road and the second road merge or connect with each other, the second road having higher priority, based on the priority rule in traffic, over the first road; and/or
the first vehicle travelling on a first lane is attempting to perform a lane change to a second lane in which a traffic jam exists, on a road including the first lane and the second lane adjacent to the first lane; and/or
there is a request from the first vehicle stopped for performing traffic-jam-cutting-in.

Suitably, the determiner is configured to determine to temporarily give priority to the first vehicle on a subordinate-side, in a case that the first vehicle stops at a position, on a first road, before a second road in which a traffic jam exists, the first road extending to a place where the first road and the second road merge or connect with each other, the second road having higher priority, based on the priority rule in traffic, than the first road; and
the generator of the server is configured to generate the travelling control information for causing the first vehicle on the first road being the subordinate-side and having lower priority based on the priority rule in traffic to travel toward the place where the first road and the second road merge or connect with each other, prior to the other vehicle travelling toward the place where the first road and the second road merge or connect with each other on the second road having higher priority based on the priority rule in traffic.

Suitably, the determiner is configured to determine to give priority to the first vehicle on a subordinate-side, in a case that the first vehicle travelling on a first lane is attempting to perform a lane change to a second lane in which a traffic jam exists, on a road including the first lane and the second lane adjacent to the first lane; and
the generator of the server is configured to generate the travelling control information causing the first vehicle on the first lane related to the lane change being the subordinate-side and having lower priority based on the priority rule in traffic to travel so as to cut into a space between the plurality of vehicles travelling on the second lane having higher priority based on the priority rule in traffic.

A server according to an aspect of a present invention is a server used for a travelling control system for vehicles, the server including:
a generator configured to generate travelling control information for a plurality of vehicles each including a controller configured to execute travelling control of an automatic driving or of a driving support in a case that the plurality of vehicles travels on a road, such that the plurality of vehicles travels based on priority following a priority rule in traffic; and
a determiner configured to determine priority with respect to the plurality of vehicles including a first vehicle intending to travel on the road, wherein:
the travelling control system is configured to send the travelling control information generated by the generator to at least one of the plurality of vehicles so as to cause the controller of the at least one of the plurality of vehicles to execute the travelling control using the travelling control information; and
in a case that the determiner has determined to give priority to the first vehicle, the generator of the server is configured to generate the travelling control information for the plurality of vehicles such that a travelling of the first vehicle has priority over a travelling of other vehicle, of the plurality of vehicles, even in a case that the first vehicle has lower priority, based on the priority rule in traffic, compared to the other vehicle.

A vehicle according to an aspect of a present invention is a vehicle used in a travelling control system for vehicles: the system including a server including a generator configured to generate travelling control information for a plurality of vehicles each including a controller configured to execute travelling control of an automatic driving or of a driving support in a case that the plurality of vehicles travels on a road such that the plurality of vehicles travels based on priority following a priority rule in traffic; the system being configured to send the travelling control information generated by the generator of the server to at least one of the plurality of vehicles so as to cause the controller of the at least one of the plurality of vehicles to execute the travelling control using the travelling control information;
the travelling control system for vehicles including a determiner configured to determine priority with respect to the plurality of vehicles including a first vehicle intending to travel on the road; and
in a case that the determiner has determined to give priority to the first vehicle, the generator of the server device is configured to generate the travelling control information for the plurality of vehicles such that a travelling of the first vehicle has priority over a travelling of other vehicle, of the plurality of vehicle, even in a case that the first vehicle has lower priority, based on the priority rule in traffic, compared to the other vehicle.

### Advantageous Effects of Invention

In the present invention, the travelling control information for the plurality of vehicles is generated in the server of the travelling control system for the vehicles, and is sent to at least one of the vehicles. The vehicle uses the travelling control information in the travelling control of the automatic driving or of the driving support. In such manner, by controlling basic travelling of at least one vehicle by the travelling control system for vehicles, the plurality vehicles including the at least one vehicle can principally avoid or suppress a collision and can travel while ensuring high level of safety and a sense of security. Especially, the generator of the server generates the travelling control information for the plurality of vehicles, basically such that the plurality of vehicles travels based on the priority following the priority rule in traffic, and thus the plurality of vehicles is less likely to give a sense of discomfort about their respective travelling to the occupant, as well as realizes smooth travelling following the priority rule in traffic.

Further, the travelling control system for the vehicles of the present invention includes the determiner configured to determine the priority among the plurality of vehicles including the first vehicle intending to travel on the road. Then, in a case that the determiner has determined to give priority to the first vehicle, the generator of the server generates the travelling control information for the plurality of vehicles, such that the travelling of the first vehicle has priority over the travelling of other vehicle even if the first vehicle has lower priority (that is, the first vehicle is on a subordinate-side) based on the priority rule in traffic compared to the other vehicle. By doing so, in the present invention, it is possible to give priority to the travelling of the first vehicle having lower priority base on the priority rule in traffic over the other vehicle by switching the priority with respect to the travelling of the plurality of vehicles based on the determining by the determiner.

As described above, in the present invention, it is possible to not only simply avoid or suppress a collision, but also obtain safety and a sense of security about the travelling of the vehicle.

### BRIEF DESCRIPTION OF DRAWINGS

FIG. 1 is a configuration diagram of a travelling control system for an automobile according to an embodiment of the present invention.

FIG. 2 is a hardware configuration diagram of a server device of FIG. 1.

FIG. 3 is a configuration diagram of a vehicle system configured to control travelling of the automobile of FIG. 1.

FIG. 4 is a flowchart of a process executed by the vehicle system of the automobile of FIG. 3 to send own automobile information.

FIG. 5 is a flowchart of a process executed by the server device of FIG. 2 to collect field information such as own automobile information of a plurality of automobiles etc.

FIG. 6 is a flowchart of a process executed by the server device of FIG. 2 to generate travelling control information used in the plurality of automobiles.

FIGS. 7A and 7B are explanatory diagrams of a current road map used in the mapping of FIG. 6

FIG. 8 is a flowchart executed by the server device of FIG. 2 to send information to the plurality of automobiles.

FIG. 9 is a flowchart executed by each of the plurality of vehicles to receive information from the server device.

FIG. 10 is a flowchart of an automatic driving control executed by each of the plurality of automobiles in the embodiment.

FIGS. 11A and 11B are explanatory diagrams of a first specific example of a travelling condition in which a first automobile on a merging road is travelling toward a main road in which a traffic jam exists.

FIGS. 12A and 12B are explanatory diagrams of a second specific example of a travelling condition in which a first automobile travelling on a carpool lane attempts to execute a lane change to an adjacent lane in which a traffic jam exists.

### DESCRIPTION OF EMBODIMENTS

Embodiments of the present invention will be described based on the drawings.

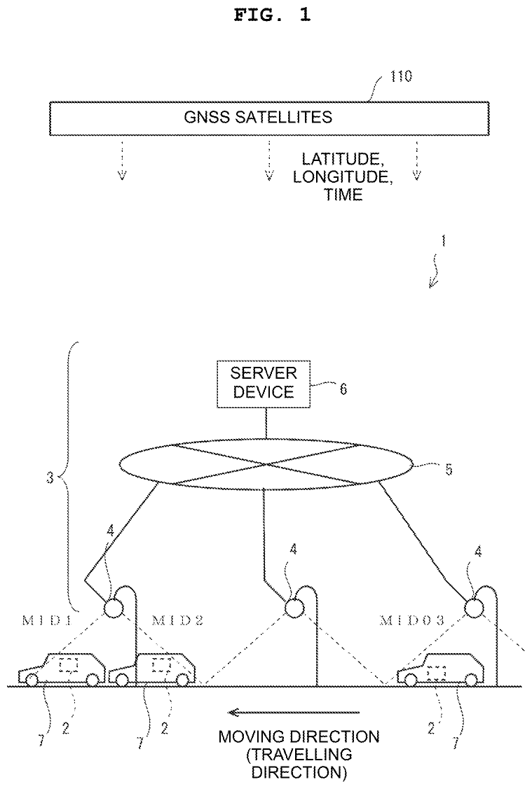

FIG. 1 a configuration diagram of a travelling control system 1 for automobiles 7, according to an embodiment of the present invention.

The travelling control system 1 of FIG. 1 includes vehicle systems 2 of a plurality of automobiles 7, and a managing system 3 configured to manage travelling of the plurality of automobiles 7.

Further, FIG. 1 depicts Global Navigation Satellite System (GNSS) satellites. The GNSS satellites 110 are positioned on satellite orbits of the Earth and emit radio waves toward the ground surface. The radio waves of the GNSS satellites contain information on latitude, longitude, and altitude indicating the position of each satellite, and information on absolute time based on which the satellites are synchronized. By receiving the radio waves from the GNSS satellites 110, it is possible to obtain the information on latitude, longitude, and altitude indicating the correct position of the receiving point at which the radio waves are received, and the correct time of the receiving point.

The automobile 7 is an example of a vehicle. The vehicle includes, for example, a motor cycle, a cart, a personal mobility, etc., other than the automobile. The automobile 7 may travel by driving force of an engine and/or a motor as a power source, change a travelling direction by an operation of a steering device, and decelerate and stop by an operation of a braking device, under the travelling control of the vehicle system 2 provided on the automobile 7.

The automobile 7 travels on a road, for example, under the travelling control of an automatic driving of the vehicle system 2. The automobile 7 may travel on the road by the travelling control of a driving support of the vehicle system 2, in a case that an occupant of the automobile 7 preforms a manual operation for the travelling of the automobile 7. Further, the vehicle system 2 may be configured such that the travelling of the automobile 7 can be controlled by the manual operation itself by the occupant.

The managing system 3 includes a plurality of wireless base stations 4, a communication network 5, and a server device (server) 6.

The plurality of wireless base stations 4 may be, for example, the wireless base stations 4 for mobile communication network services for mobile terminals, etc., and/or base stations for ITS services to the automobiles 7. The wireless base stations 4 for the mobile communication network services include, for example, base stations of the fourth-generation and base stations of the fifth-generation. The wireless base stations 4 may be fixedly installed on, for example, road shoulders, road surfaces, or buildings; or installed on moving bodies such as the automobiles 7, ships, drones, airplanes, etc.

The wireless base station 4 establishes a wireless communication path for sending and receiving information with an AP communication apparatus 70 of the vehicle system 2 of the automobile 7 that exists within radio wave reachable range (radio wave coverage) of the base station 4. In a case that the automobile 7 travelling on the road moves out of the radio wave reachable range, the wireless base station 4 that establishes the wireless communication path is switched among the plurality of wireless base stations 4. This allows the automobile 7 to keep on establishing the wireless communication path constantly during the travelling, for example, by the plurality of wireless base stations 4 arranged along the road. The wireless communication path established between the based station of the fifth-generation and the automobile 7 can send and receive significantly more information than that established between the base station of the fourth-generation and the automobile 7. In addition, the base station of the fifth-generation can be equipped with advanced information processing capability, and with the function of sending and receiving information between the base stations. In a V2V communication of the automobile 7, the automobiles 7 may send and receive information directly to each other, or the automobiles 7 may send and receive information to each other via the base station of the fifth-generation.

A plurality of wireless base stations 4 and the server device 6 are connected to the communication network 5.

The communication network 5 may be configured by, for example, a communication network 5 dedicated to the mobile communication network services, a communication network 5 dedicated to the ITS services, and/or the Internet connecting the communication networks 5 to each other, etc. The communication network 5 may include a dedicated communication network 5 newly provided for the travelling control system 1.

The Internet is a public and open wide-area communications network. Other than the Internet, the wide-area communication network includes, for example, dedicated communication networks 5 used in advanced transportation systems such as Advanced driver-assistance systems (ADAS), and ATM switching networks used exclusively for telephone switching. The travelling control system 1 may use these wide-area communication networks instead of or together with the dedicated network. Open networks tend to have larger transmission delays than closed networks, but they can maintain a certain degree of confidentiality by encrypting or otherwise encoding data. However, by using a dedicated network, in data communication between the plurality of wireless base stations 4 and the server device 6, it is possible to mutually stably perform, low latency, large-volume, and high-speed communication, compared to the case of using the Internet, etc. Even if the dedicated network is configured to send and receive information using asynchronous frames based on TCP/IP protocols, etc., and resend frames due to collision detection, etc., the transmission delay caused by these processes is difficult to become excessively large. In dedicated networks, transmission delays can be kept small compared to the Internet, where large amounts of data may be sent and received asynchronously.

The Server device (server) 6 is a computer device configured to manage travelling of the plurality of automobiles 7.

The server device 6 may be configured by a plurality of computer devices, unlike FIG. 1.

The server device 6 may be configured by a plurality of computer devices to each of which function of the server device 6 is allotted function by function basis.

The plurality of computer devices as the server device 6 may be dispersedly arranged, for example, at the plurality of wireless base stations 4 etc.

The plurality of computer devices as the server devices 6 may be multi-layered.

The plurality of computer devices as the server device 6 may be configured by lower level computer devices dispersedly arranged at, for example, the plurality of wireless base stations 4, etc, and a higher level computer device(s) that supervises and manages the dispersed lower level computer devices.

In any case, a processing load of an individual computer device can be reduced by cooperation of the plurality of computer devices to function as the server device 6.

In addition, by realizing the dispersed arrangement of the plurality of server devices 6 with respect to the communication network 5 appropriately, it is possible to limit the range in which each piece of information is transmitted, and thereby a transmission load and a transmission delay are reduced.

Each of the plurality of server devices 6 dispersed such that the plurality of server devices 6 correspond to the plurality of wireless base stations 4, respectively, may be integrated with the wireless base station 4 and may be provided as one of the functions of the wireless base station 4. Such a wireless base station 4 having the function of the dispersed server device 6 can minimize the transmission delay time of information. The wireless base station 4 having the function of the dispersed server device 6 can function as a part of the components of the vehicle system 2 of the automobile 7, for example, by substituting execution of some of the processes of the vehicle system 2 of the automobile 7. The plurality of wireless base stations 4 may realize the process of the server device 6 or the vehicle system 2 of the automobile 7 by, for example, performing cooperative process in which the plurality of wireless base stations 4 communicate with each other without perform a communication through the server device 6. In this case, each of the plurality of wireless base stations 4 fixedly installed to a road may, for example, classify the information of the plurality of automobiles 7 accommodated in its communication area into a plurality of road maps based on their positions within the communication areas, etc., group the information of the plurality of automobiles 7 based on the classification of the road, and relay and forward the grouped information to a plurality of other wireless base stations 4. The server device 6 other than the plurality of wireless base stations 4 may be omitted. The processing of the server device 6 may be realized dispersedly by cooperative processing between the plurality of wireless base stations 4 and the server device 6.

In the travelling control system 1 such as described above, each of the automobiles 7 establishes the wireless communication path with at least one wireless base station 4. Each of the automobiles 7 can keep on establishing the wireless communication path by switching the wireless base station 4 while travelling. This allows information to be sent and received between the plurality of automobiles 7 and the server device 6.

Each of the plurality of automobiles 7 can repeatedly send information on its driving condition to the server device 6 in a relatively short cycle. The information on the driving condition sent by each of the automobiles 7 includes, for example, travelling information of each of the automobiles 7, occupant information about a user, and surrounding information of each of the automobile 7. The travelling information of the automobile 7 includes, for example, a current position, a destination, a posture and a movement of the body of the automobile 7, as well as a travelling direction and a travelling speed. The posture of the body of the automobile 7 includes, for example, a yaw rate.

The server device 6 can repeatedly receive and collect field information from each of the plurality of automobiles 7 in a relatively short cycle, the field information including the respective driving condition of the plurality of automobiles 7. The field information may include, for example, road monitoring information from cameras, etc. installed on the road, information indicating the travelling conditions of the plurality of automobile 7 obtained from other server device 6, regional traffic information, etc., in addition to own automobile information (that is, information on itself or information on the automobile having itself) sent from each of the plurality of automobiles 7.

The server device 6 may perform mapping of the collected travelling conditions of the plurality of automobiles 7 onto a current road map 80, etc., so as to generate travelling control information for each of the plurality of automobiles 7. Here, the travelling control information may be, for example, a course (travelling amount) or a travelable range in a small (minute) time period or in a small (minute) section of the automobile 7. The travelling control information may also include a speed or an amount of acceleration and/or deceleration, an amount of steering, or a direction of the course of the automobile 7.

The server device 6 can repeatedly send the travelling control information for each of the plurality of automobiles 7 to the plurality of automobiles 7 in a relatively short cycle. Further, the server device 6 may send the travelling control information of the plurality of automobiles 7 to other server device(s) 6.

Each of the plurality of automobiles 7 can repeatedly receive the travelling control information for itself from the server device 6 in a relatively short cycle.

Each of the plurality of automobiles 7 can execute the travelling control for itself by using the travelling control information received from the server device 6.

Thereby, each of the plurality of automobiles 7 can continue its travelling by using the travelling control information repeatedly received from the server device 6 in a relatively short cycle.

By the server device 6 continuing to generate the travelling control information for the plurality of automobiles 7 based on which, for example, collision or approaching with respect to other automobile are not caused, the plurality of automobiles 7 can continue to execute the travelling control that is basically safe and that gives a sense of security to the occupant(s). Each of the plurality of automobile 7 can execute the travelling that is safe and that gives a sense of security to the occupant(s) from the current position to the desired destination, by obtaining the travelling control information for each of the small sections continuously and repeatedly, and controlling the travelling according to the obtained travelling control information.

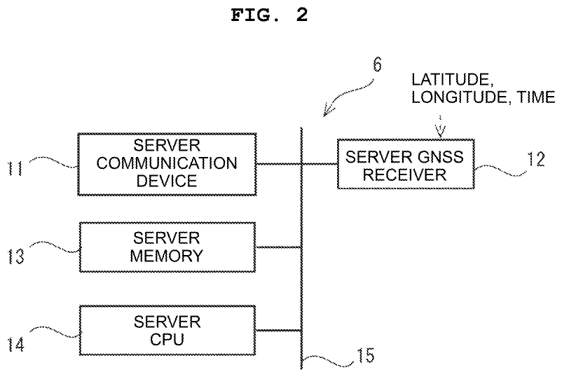

FIG. 2 is a hardware configuration diagram of the server device 6 of FIG. 1. The server device 6 of FIG. 2 includes a server communication device 11, a server GNSS receiver 12, a server memory 13, a server CPU 14, and a server bus 15 to which the server communication device 11, the server GNSS receiver 12, the server memory 13, and the server CPU 14 are connected.

The server communication device 11 is connected to the communication network 5. The server communication device 11 sends and receives information to and from other devices connected to the communication network 5, such as for example, the wireless base station 4 and/or the vehicle system 2 of the automobile 7.

The server GNSS receiver 12 receives the radio waves from the GNSS satellites 110 to obtain the current time. The server device 6 may be equipped with an undepicted server timer that is calibrated by the current time of the server GNSS receiver 12.

The server memory 13 records programs and data to be executed by the server CPU 14.

The server CPU 14 reads the program from the server memory 13 and executes the program. With this, a server controller (server control unit) is realized in the server device 6.

The server CPU 14 as the server controller manages the overall operation of the server device 6.

The server CPU 14 as the server controller also functions as a controller for the entire of the travelling control system 1. The server CPU 14 manages and controls the travelling of the plurality of automobiles 7. The server CPU 14 collects the field information including the travelling conditions of the plurality of automobiles 7, generates the driving control information for the plurality of automobiles 7 so that the travelling of the plurality of automobiles 7 becomes smooth basically and safety and a sense of security of the travelling of the plurality of automobiles 7 is maximized, and send the generated driving control information to each of the plurality of automobiles 7.

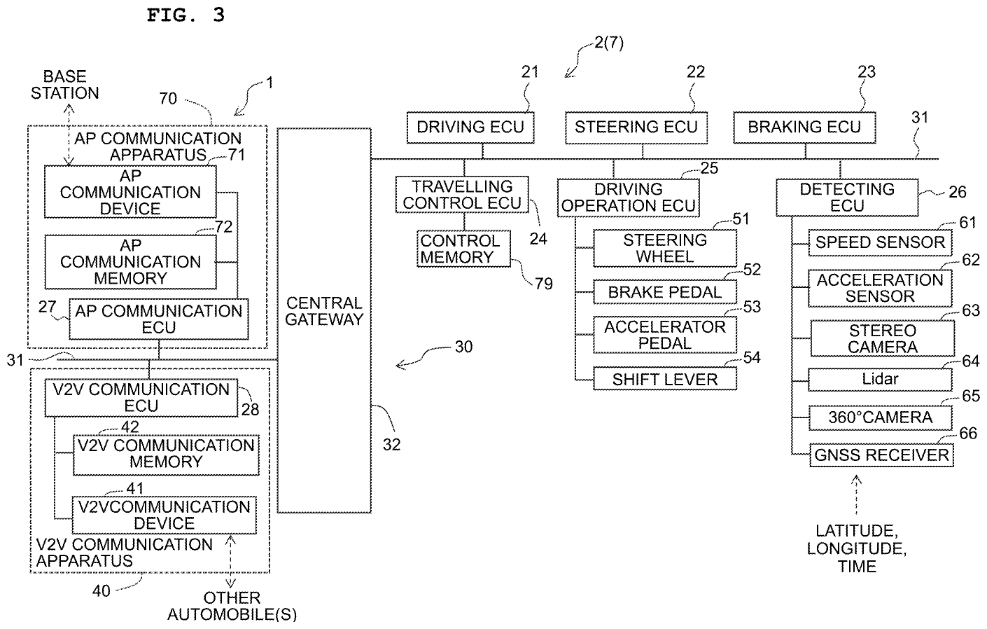

FIG. 3 is a configuration diagram of the vehicle system 2 configured to control the travelling of the automobile 7 of FIG. 1.

The vehicle system 2 provided in the automobile 7 of FIG. 3 is representatively depicted by a plurality of control ECUs (Electronic Control Units) into each of which a plurality of control devices is incorporated. The control devices may include, like the server device of FIG. 2 and in addition to the control ECUs, for example, a memory configured to record control programs and data, an input-output port, a timer configured to measure time (time period) and time, and an internal bus to which those components are connected.

FIG. 3 depicts, as the plurality of control ECUs for the vehicle system 2 of the automobile 7, for example, a driving ECU 21, a steering ECU 22, a braking ECU 23, a travelling control ECU 24, a driving operation ECU 25, a detecting ECU 26, an AP communication ECU 27, and a V2V communication ECU 28. The vehicle system 2 of the automobile 7 may include other control ECUs not depicted in the drawing.

The plurality of control ECUs are connected to an automobile network 30, such as CAN (Controller Area Network) and/or LIN (Local Interconnect Network), for example, employed in the automobile 7. The automobile network 30 may be configured by a plurality of bus cables 31 capable of connecting the plurality of control ECUs and a central gateway (CGW) 32 as a relay device to which the plurality of bus cables 31 are connected. An ID is assigned to each of the plurality of control ECUs as identification information different from each other among the plurality of control ECUs. A control ECU basically outputs data to other control ECUs periodically. The ID of the output source control ECU and the ID of the output destination control ECU are added to the data. Each of other control ECUs monitors the bus cable 31, and if the ID of the output destination is, for example, its own, it obtains the data and executes a process based on the data. The central gateway 32 monitors each of the plurality of bus cables 31 connected to the central gateway 32, and if the central gateway 32 detects the control ECU connected to one bus cable 31 different from the bus cable 31 to which the control ECU of the output origin is connected, then the central gateway 32 outputs the data to the one bus cable 31. Owing to a relay process such as above performed by the central gateway 32, the plurality of control ECUs can perform inputting and outputting of data between first control ECUs connected to a first bus cable 31 and second control ECUs, different from the first control ECUs, connected to a second bus cable 31 different from the first bus cable.

For example, a steering wheel 51, a brake pedal 52, an accelerator pedal 53, a shift lever 54, etc. are connected to the driving operation ECU 25, as operating components for the user to control the travelling of the automobile 7. In a case that the operating components are operated, the driving operation ECU 25 outputs data including the presence or absence of the operation and the operation amount to the automobile network 30. Further, the driving operation ECU 25 may execute a process regarding the operation to the operating components, and include the result of the process into the data. For example, in a case that the accelerator pedal 53 is operated in a situation where another automobile and/or a fixed object exists in the moving direction of the automobile 7, the driving operation ECU 25 may determine the abnormal operation, and include the result of the determination into the data.

For example, a speed sensor 61 configured to detect a speed (velocity) of the automobile 7, an acceleration sensor 62 configured to detect a rate of acceleration of the automobile 7, a stereo camera 63 configured to image the outside surroundings of the automobile 7, a LIDAR 64 configured to detect objects existing around the automobile 7 by laser radiation, a 360 degrees camera (360° camera) 65 configured to image a surrounding of the automobile 7 in a range of 360 degrees, the GNSS receiver 66 configured to detect a position of the automobile 7, etc. are connected to the detecting ECU 26, as detecting components configured to detect a travelling condition of the automobile 7. The GNSS receiver 66 receives the radio waves from the GNSS satellites 110 similar to or same as those for the server GNSS receiver 12, and obtains latitude, longitude, and altitude those being the current position of the own automobile (that is, itself, or the automobile having itself), and the current time. The current time of the automobile 7 is thus expected to match the current time by the server GNSS receiver 12 of the server device 6 with a high degree of accuracy. The detecting ECU 26 obtains detecting information from the detecting components and outputs data including the detecting information to the automobile network 30. Further, the detecting ECU 26 may execute a process based on the detecting information and include the result of the process into the data. For example, in a case that the acceleration sensor 62 detects the rate of acceleration over a collision detecting threshold, the detecting ECU 26 determines a collision detection, and may include the result of the collision detection into the data. The detecting ECU 26 may extract, based on the image obtained by the stereo camera 63, a pedestrian and/or another automobile 7 existing around the own automobile: determine a type and/or an attribute of the automobile 7; estimate a relative direction, a relative distance, and/or a travelling direction of the automobile 7 depending on a position, a size and/or a change of the automobile 7 on the image; and output the data to the automobile network 30 in a state that information obtained as a result of the estimation is included in the data.

An AP communication device 71, and an AP communication memory 72 are connected to the AP communication ECU 27. The AP communication ECU 27, the AP communication device 71, and the AP communication memory 72 constitute an AP communication apparatus 70 configured to establish, in the automobile 7, the wireless communication circuit between the automobile 7 and the wireless base station 4. The AP communication device 71 sends and receives data that is sent and received by the AP communication ECU 27 with respect to the wireless base station 4 outside the automobile 7. The AP communication memory 72 is a computer-readable recording medium, and records a program to be executed by the AP communication ECU 27, setting values, and data to be sent and received by the AP communication ECU 27. The AP communication ECU 27 sends and receives data to and from the server device 6 by using the AP communication device 71. The AP communication ECU 27 collects own automobile information through the automobile network 30, for example, and sends the collected information to the server device 6. The AP communication ECU 27 obtains, for example, travelling control information etc. sent by the server device 6 to the own automobile, from the AP communication device 71, and records the obtained information in the AP communication memory 72.

The own automobile information collected by the AP communication ECU 27 includes, for example, in-car information such as the condition of the user in the car, information on the travelling condition of the own automobile, surrounding information such as the travelling environment of the own automobile, area information of the area in which the own automobile travels. The surrounding information may include information on other automobile(s) existing around the own automobile. The information on the travelling condition of the own automobile includes, for example, information based on autonomous sensors (sensors mounted on the automobile: acceleration, GPS, gyro, electronic compass, barometric pressure, camera, radar, ultrasonic, infrared rays, etc.) such as those described above provided on the own automobile 7. Autonomous sensors may detect information indicating the travelling condition of the own automobile, automobile information such as user information and car number of the own automobile, surrounding information or area information of the own automobile. The information on the travelling condition of the own automobile may include information on the travelling condition that can be calculated based on the detecting performed by those sensors, for example, a yaw rate. The own automobile information sent from the AP communication ECU 27 may be the own automobile information itself collected by the AP communication ECU 27, or may be information obtained by applying processing, filtering, coding, and/or quantization to the information collected. The AP communication ECU 27 sends the own automobile information to be sent to the server device 6 to the wireless base station 4 periodically and repeatedly.

The information that the AP communication ECU 27 obtains from the server device 6 includes the travelling control information used for the travelling control of the own automobile, etc. The AP communication ECU 27 periodically and repeatedly receives the travelling control information etc. to be obtained from the server device 6, from the wireless base station 4.

A V2V communication device 41 and a V2V communication memory 42 are connected to the V2V communication ECU 28. The V2V communication ECU 28, the V2V communication device 41, and the V2V communication memory 42 constitute a V2V communication apparatus 40 configured to execute direct communication with other automobiles, in the automobile 7. The V2V communication device 41 sends and receives data send and received by the V2V communication ECU 28 via an inter-vehicle communication with the V2V communication apparatus 40 of another automobile. The V2V communication memory 42 is a computer-readable recording medium configured to record programs to be executed by the V2V communication ECU 28, setting values, and data send and received by the V2V communication ECU 28. The V2V communication ECU 28 uses the V2V communication device 41 to send and receive data to and from the V2V communication apparatus 40 of another automobile. The V2V communication ECU 28 collects V2V communication information generated in the vehicle system 2 via the automobile network 30 for example, and send the collected information to the V2V communication apparatus 40 of another automobile. The V2V communication ECU 28 obtains, for example, information sent by the V2V communication apparatus 40 of another automobile to the own automobile from the V2V communication device 41, and records the obtained information in the V2V communication memory 42.

Note that a portable terminal, etc. can be used for the AP communication apparatus 70 and/or the V2V communication apparatus 40. In this case, the portable terminal may be connected to the automobile network 30 by the bus cable 31 or via an undepicted wireless router connected to the automobile network 30.

A control memory 79 is connected to the travelling control ECU 24. The control memory 79 is a computer-readable recording medium in which programs to be executed by the travelling control ECU 24, setting values, etc. are recorded. The control memory 79 may record information on the control contents by the travelling control ECU 24. The travelling control ECU 24 reads the program from the control memory 79 and executes the read program. By doing so, the travelling control ECU 24 may function as a controller (a control unit) configured to control the travelling of the automobile 7.

The travelling control ECU 24 obtains information from, for example, the AP communication ECU 27, the V2V communication ECU 28, the detecting ECU 26, the driving operation ECU 25, etc. through the automobile network 30, and executes the control of an automatic driving or a manual driving support for the travelling of the automobile 7. The driving control ECU 24 generates driving control data for controlling the travelling of the automobile 7 based on the obtained information. For example, the travelling control ECU 24 generates the travelling control data based on the travelling control information obtained from the AP communication ECU 27 so as to control the travelling of the automobile 7 basically following the travelling control information. The travelling control ECU 24 outputs the generated travelling control data to the driving ECU 21, the steering ECU 22, and the braking ECU 23. The driving ECU 21, the steering ECU 22, and the braking ECU 23 control the travelling of the automobile 7 according to the inputted travelling control data.

As described above, the plurality of automobile 7 each including the vehicle system 2 of FIG. 3 is capable of executing the travelling control of the automatic driving or of the driving support, in a case that the plurality of automobile 7 travels on the road.

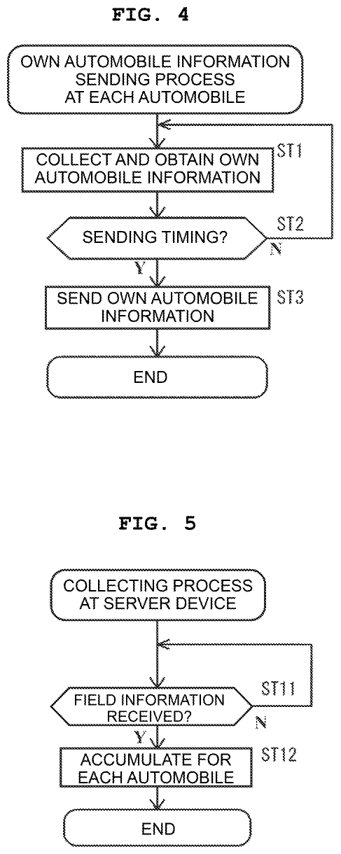

FIG. 4 is a flowchart of a process performed by the vehicle system 2 of the automobile 7 of FIG. 3 to send the own automobile information.

In the vehicle system 2 of the automobile 7 of FIG. 3, for example, the AP communication ECU 27 may execute the process of sending the own automobile information of FIG. 4. In a case that, for example, the AP communication ECU 27 is in a state that the communication with the wireless base station 4 is possible, the AP communication ECU 27 executes the process of sending the own automobile information of FIG. 4 periodically and repeatedly. The cycle of the sending of the own automobile information by the AP communication ECU 27 may be in a range of tens of milliseconds to several seconds, for example.

In a step ST1, the AP communication ECU 27 collects and obtains the own automobile information from each part of the automobile 7. The AP communication ECU 27 collects the own automobile information from the driving control ECU 24, the detecting ECU 26, the driving operation ECU 25, etc. through the automobile network 30, for example. The own automobile information may include, for example, the travelling condition of the own automobile such as the current position of the own automobile, the current time, the travelling direction, the travelling speed, the yaw rate; the condition of the user in the car; information on the surroundings of the own automobile; and information on the area in which the own automobile is travelling. The AP communication ECU 27 records the collected own automobile information in the AP communication memory 72.

In a step ST2, the AP communication ECU 27 determines whether or not it is a timing for sending the own automobile information. The timing for sending the own automobile information may occur in a regular cycle. The AP communication ECU 27 may determine, based on the current time of the GNSS receiver 66 or the time of the timer provided in the automobile 7 for example, whether or not the elapsed time since the previous sending timing has exceeded a predetermined sending cycle, and may determine that it is the timing for sending the own automobile information in a case that the elapsed time has exceeded the predetermined sending cycle. In this case, the AP communication ECU 27 advances the process to a step ST3. In a case that it is not the timing for sending the own automobile information, the AP communication ECU 27 returns the process to the step ST1.

In the step ST3, the AP communication ECU 27 sends the information collected in the step ST1 from the AP communication device 71 to the server device 6. The AP communication device 71 reads the own automobile information from the AP communication memory 72, and sends the read own automobile information to the server device 6 through the base station with which the wireless communication path is established. The sent information from the AP communication device 71 of the automobile 7 will be sent to the server device 6 through the communication network 5 after being received by the wireless base station 4. The sent information from the AP communication device 71 may include information such as the position, time and ID etc. of the automobile 7 at a timing at which the AP communication device 71 executes the sending.

FIG. 5 is a flowchart of a process performed by the server device 6 of FIG. 2 to collect field information, such as the own automobile information of a plurality of automobiles 7.

The server CPU 14 of the server device 6 of FIG. 2 may execute the process of collecting field information of FIG. 5 each time the server communication device 11 receives new information.

In step ST11, the server CPU 14 determines whether or not the server communication device 11 has received the field information such as the own automobile information of the plurality of automobiles 7 as new information. In a case that the server communication device 11 has not received any field information, the server CPU 14 repeats the step ST11. In a case that the server communication device 11 receives the field information, the server CPU 14 advances the process to the step ST12.

In the step ST12, the server CPU 14 stores the received field information in the server memory 13. The server CPU 14 may classify the received field information automobile 7 by automobile 7 basis, for example, and store the classified field information in the server memory 13. By doing so, information indicating the travelling condition of a plurality of automobiles 7 of which travelling is managed by the server device 6 is accumulated in the server memory 13 of the server device 6. The information accumulated in the server memory 13 may be continuously updated to the latest information at each sending cycle of the own automobile information of the vehicle system 2 of the automobile 7, for example.

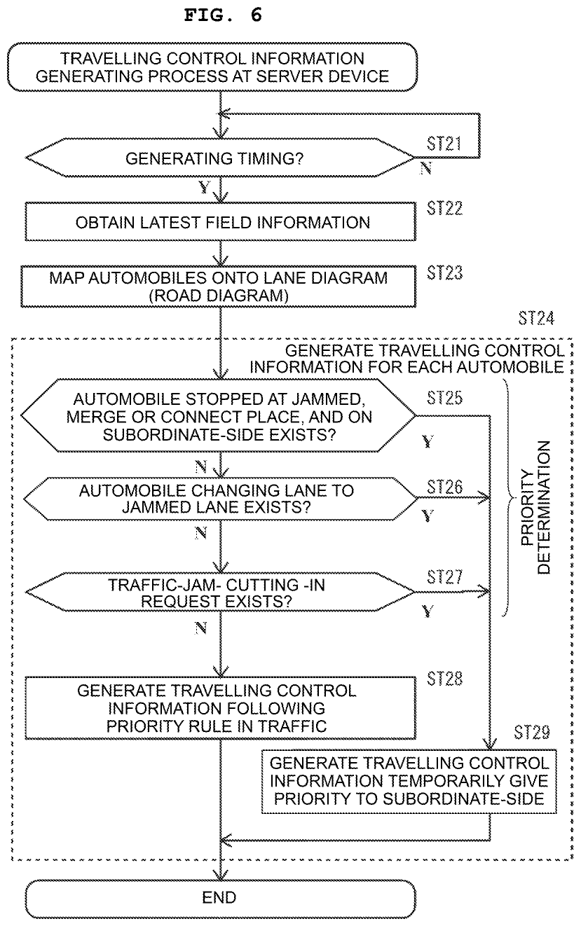

FIG. 6 is a flowchart of a process performed by the server device 6 of FIG. 2 to generate travelling control information used in a plurality of automobiles 7.

The server CPU 14 of the server device 6 of FIG. 2 may execute the process of generating travelling control information of FIG. 6 at each predetermined generating timing.

In a step ST21, the server CPU 14 determines whether or not it is a timing to generate new travelling control information for the plurality of automobiles 7. The server CPU 14 may determine, based on the current time of the server GNSS receiver 12, whether or not the elapsed time since the previous generation timing has exceeded a predetermined generating cycle. In a case that the elapsed time has not exceeded the generating cycle, the server CPU 14 repeats the determining process of the step ST21. If the elapsed time has exceeded the generating cycle, the server CPU 14 determines that it is the timing to generate new travelling control information and advances the process to a step ST22.

In the step ST22, the server CPU 14 obtains, from the server memory 13, the latest field information on the travelling conditions of the plurality of automobiles 7 that has been accumulated by the receiving performed by the server communication device 11.

In a step ST23, the server CPU 14 identifies the current positions of the plurality of automobiles 7 by using the latest field information and maps the current travelling conditions of the plurality of automobiles 7 onto the current road map 80. Other than that, the travelling conditions in future predicted based on the current information of each of the automobiles 7 such as, for example, a trajectory based on the current speed, may be mapped onto the current road map 80. In this case, the current position of each of the automobiles 7 as well as predicted position in future of each of the automobiles 7 will be mapped onto the current road map 80. The server CPU 14 may record the current road map 80 onto which the current travelling conditions of the plurality of automobiles 7 are mapped in the server memory 13.

In a step ST24, the server CPU 14 generates the travelling control information used by the plurality of automobiles 7 managed by the travelling control system 1 in their respective travelling control, by using the current road map 80 onto which the current travelling conditions of the plurality of automobiles 7 are mapped. The server CPU 14 generates, as the travelling control information for each of the automobiles 7, the travelling control information based on which the automobile 7 basically travels based on priority following the priority-rule in traffic (straight travelling has priority) and which realizes the travelling being as safe and secure as possible. The server CPU 14 may generate, for example, the travelling control information by which the automobile 7 travels with sufficient following distances in a state that the automobile 7 is apart from each of other automobiles travelling in front of and in rear of itself and on the same lane as itself not less than a predetermined distance. The server CPU 14 may record the travelling control information generated for the plurality of automobiles 7 in the server memory 13.

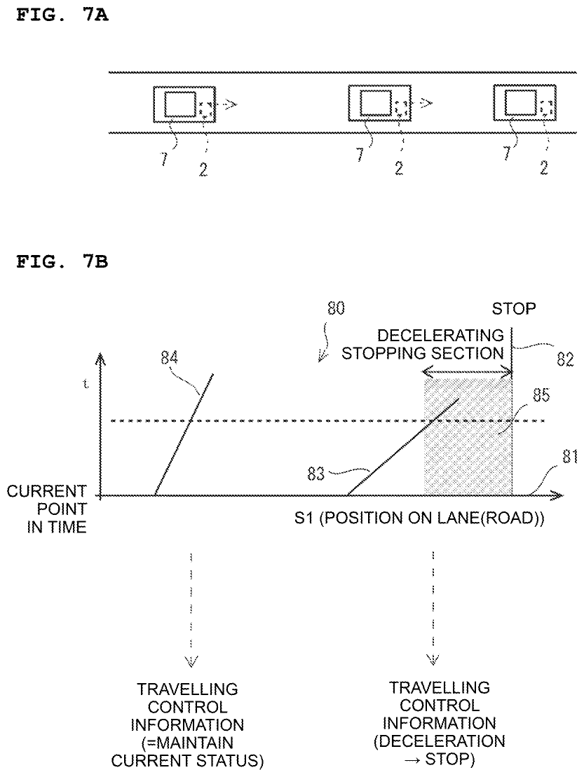

FIGS. 7A and 7B are explanatory diagrams of the current road map 80 used for the mapping of FIG. 6.

FIG. 7A is an explanatory diagram of a travelling condition in which the plurality of automobiles 7 travels in a row on a road with single lane.

FIG. 7B is a current road map 80 regarding the road with single lane of FIG. 7A.

The current road map 80 may be provided, for example, for each lane of the area or the road for which the travelling control system 1 manages the travelling of the automobile 7. That is, for a road having a plurality of lanes, there may be a plurality of current road maps 80 corresponding to the plurality of lanes respectively. Further, in a case that the merging road is connected to the main road, there may be the current road map 80 corresponding to the main road and the current road map 80 corresponding to the merging road.

In the current road map 80 of FIG. 7B, the horizontal axis 81 indicates a position on the lane (road). The vertical axis indicates time. The time flows from the bottom to the top. The origin corresponds to the current point in time (present point in time).

In FIG. 7A, three automobiles 7 are travelling on the road with single lane.

In this case, the server CPU 14 generates the current road map 80 of FIG. 7B in the step ST23 of FIG. 6. In the current road map 80 of FIG. 7B, three trajectories 82 to 84 corresponding respectively to the three automobiles 7 will be mapped.

The trajectory 84 corresponding to the automobile 7 at the left-end of FIG. 7A will be mapped onto the left part of FIG. 7B near the origin. The trajectory 84 is inclined because the automobile 7 at the left-end of FIG. 7A is travelling at a speed different from zero. The inclination of the trajectory 84 increases or decreases in response to the current (present) speed of the automobile 7.

The trajectory 83 corresponding to the automobile 7 at the center of FIG. 7A will be mapped onto the center part of FIG. 7B. The trajectory 83 is inclined because the automobile 7 at the center of FIG. 7A is travelling at a speed different from zero. Because the speed of the automobile 7 in the center of FIG. 7A is large, the trajectory 83 is inclines greatly with respect to the vertical axis.

The trajectory 82 corresponding to the automobile 7 at the right-end of FIG. 7A will be mapped onto the right part of FIG. 7B. The trajectory 82 is in parallel with the vertical axis because the automobile 7 at the right-end of FIG. 7A is stopped and its speed is zero.

In this case, the server CPU 14 may generate, in the step ST24 of FIG. 6 and as the travelling control information for the automobile 7 at the left-end of FIG. 7A, the travelling control information to continue travelling while maintaining the current speed.

Further, it is predicted that if the automobile 7 at the center of FIG. 7A continues travelling maintaining the current condition, the automobile 7 at the center of FIG. 7A reaches the decelerating stopping section 85 of the automobile 7 at the right-end of FIG. 7A being stopped. Thus, the server CPU 14 may generate the travelling control information to decelerate the automobile 7 at the center of FIG. 7A such that the automobile 7 at the center of FIG. 7A can stop in the decelerating stopping section 85 in front of the automobile 7 at the right-end of FIG. 7A.

In such a manner, the server CPU 14 generates, based on the collected field information and as the travelling control information for the plurality of automobiles 7, the travelling control information capable of ensuring safety and security as much as possible by suppressing abnormal approaching and/or the merging interference from occurring.

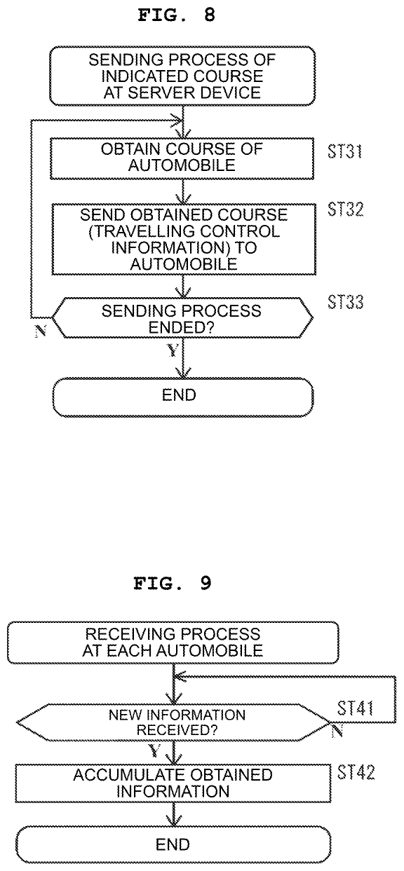

FIG. 8 is a flowchart of a process performed by the server device 6 of FIG. 2 to send information to the plurality of automobiles 7.

The server CPU 14 of the server device 6 of FIG. 2 may execute the sending process of FIG. 8 at each predetermined sending timing.

In a step ST31, the server CPU 14 obtains the latest travelling control information for the automobile 7 recorded in the server memory 13.

In the step ST32, the server CPU 14 sends the obtained travelling control information to the automobile 7 corresponding thereto. The server communication device 11 sends the travelling control information obtained by the server CPU 14 to the automobile 7 through the communication network 5 and the wireless base station 4.

In the step ST33, the server CPU 14 determines whether or not the process of sending the travelling control information has been completed for the plurality of automobiles 7 under its management. In a case that the process of sending the travelling control information has not been completed for the plurality of automobile 7, the server CPU 14 returns the process to the step ST31. The server CPU 14 repeats the process from the step ST31 to the step ST33 for the next automobile 7. In a case that the process of sending the travelling control information is completed for the plurality of automobiles 7, the server CPU 14 terminates this process.

FIG. 9 is a flowchart of a process performed by each of the plurality of automobiles 7 to receive information from the server device 6.

In the vehicle system 2 of the automobile 7 of FIG. 3, for example, the AP communication ECU 27 may execute the receiving process of FIG. 9. The AP communication ECU 27 can receive the information from the server device 6, if the AP communication ECU 27 is in a state that it is capable of communicating with the wireless base station 4, for example.

In a step ST41, the AP communication ECU 27 determines whether or not the AP communication device 71 has received new information addressed to the own automobile. The AP communication device 71 is capable of receiving new information from the server device 6. In a case that the AP communication device 71 has not received the new information from the server device 6, the AP communication ECU 27 determines that the new information has not been received, and repeats the step ST41. In a case that the AP communication device 71 receives the new information from the server device 6, the AP communication ECU 27 advances the process to a step ST42.

In the step ST42, the AP communication ECU 27 stores the received information in the AP communication memory 72. By doing so, the information received by the AP communication device 71 from the server device 6, such as for example, the travelling control information and a merging interference predicting result etc. described above, is accumulated and stored in the AP communication memory 72.

Note that the AP communication ECU 27 may overwrite the information received in the past and already recorded in the AP communication memory 72 by the information newly received.

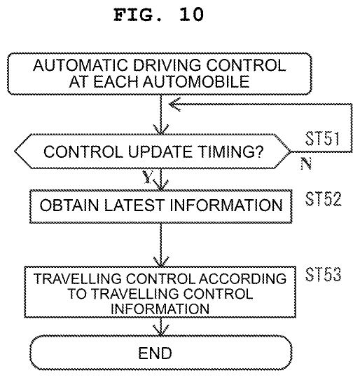

FIG. 10 is a flowchart of an automatic driving control executed by each of the plurality of automobiles 7, in the embodiment.

In the vehicle system 2 of the automobile 7 of FIG. 3, for example, the travelling control ECU 24 may execute the automatic driving control of FIG. 10. The driving control ECU 24 may repeatedly execute the automatic driving control of FIG. 10, for example, in the generating cycle of the travelling control information at the server device 6.

In a step ST51, the travelling control ECU 24 determines whether or not it is a timing to update the control. The travelling control ECU 24 may determine, based on the current time of the GNSS receiver 66, whether or not the elapsed time since the previous control timing has exceeded a predetermined update cycle. Further, the driving control ECU 24 may estimate the end time of the control of the course currently executing and determine whether or not the remaining time until the estimated end time is less than a threshold value. Then, in a case that it is not the control update timing, the travelling control ECU 24 repeats the step ST51. In a case that the control update timing has passed, the travelling control ECU 24 advances the process to a step ST52.

In the step ST52, the travelling control ECU 24 obtains the latest information. The travelling control ECU 24 obtains the latest travelling control information etc. from the AP communication memory 72. The travelling control ECU 24 may obtain detection information of the autonomous sensor of the own automobile, etc. The detection information of the autonomous sensor of the own automobile may include, for example, the current position of the automobile 7, the current time, the current speed of the automobile 7 as a result of the previous travelling control, the travelling direction, and information on other automobiles around the own automobile.

In a step ST53, the travelling control ECU 24 executes travelling control of the own automobile based on various latest information obtained in the step ST52.

For example, in a case that the detection information of the autonomous sensor indicates that the travelling condition of the own automobile has no problem, the travelling control ECU 24 may execute the travelling control of the own automobile such that the own automobile travels according to the course indicated in the latest travelling control information, based on the latest travelling control information obtained.

Based on the obtained information, the travelling control ECU 24 generates the travelling control data to control the travelling of the automobile 7 and outputs the data to the driving ECU 21, the steering ECU 22, and the braking ECU 23. The driving ECU 21, the steering ECU 22, and the braking ECU 23 control the travelling of the automobile 7 according to the travelling control data inputted thereto.

In such a manner, each of the plurality of automobiles 7 receives the travelling control information generated and sent to the plurality of automobiles 7 by the server device 6, and executes the travelling control using the travelling control information. Note that the server device 6 may send the travelling control information to at least one automobile 7 among the plurality of automobiles 7.

In such a manner, each of the plurality of automobiles 7, or at least one automobile 7 having received the travelling control information controls its travelling such that its travelling is in accordance with the travelling control information generated in the server device 6 for respective of the plurality of automobiles 7, and thereby it becomes difficult to occur a collision and/or an abnormal approaching between the plurality of automobiles 7.

On the other hand, if, for example, each of the plurality of automobiles 7 controls its own travelling individually, the possibility of occurrence of collisions and/or abnormal approaches between the plurality of vehicles 7 will increase due to, for example, different determinations made among the plurality of automobiles 7. In this case, it is difficult for each of the automobiles 7 to achieve a high level of safety and/or a sense of security, even if they are travelling under the automatic driving or the driving support. Even if the plurality of automobiles 7 inform their determination and/or content of travelling control to each other via the V2V communication, there is not a small possibility that the plurality of automobiles 7 approach each other or contact with each other in some cases at the merging section etc. It is difficult to say that the travelling of the automobiles 7 will ensure sufficient safety. Further, the occupant(s) will feel anxiety about the approaching of other vehicles.

By the way, it is considered that the basically safe, secure, and smooth travelling of the plurality of automobiles 7 is made possible owing to the generating of the travelling control information of the plurality of automobiles 7 such that they travel following the priority rule in traffic as described above, and the plurality of automobiles 7 controlling their travelling in accordance with the travelling control information for respective of the plurality of automobiles 7.

However, the priority rule in traffic includes, for example, main lane has priority at a place where a plurality of roads merges or a place where a plurality of lanes merges, straight travelling has priority at a place where a plurality of roads connects to each other by crossing etc., and straight travelling has priority in each lane in a road having a plurality of lanes, etc. In a case that the server device 6 generates the travelling control information for the plurality of automobiles 7 strictly following one of those rules, it is considered that there is a possibility that safety and security can be ensured but smooth travelling cannot be achieved.

Further, the place where the plurality of roads merges or the place where the plurality of lanes merges may include not only a section where two roads or two lanes are provided side by side, but also a place where two roads or two lanes merge formed temporarily by lane regulations due to construction etc.

Next, measures against those situations taken by the embodiment will be described.

In the step ST24 of FIG. 6, the server CPU 14 of the server device 6 generates the travelling control information for the plurality of automobiles 7 managed by the travelling control system 1. In this step, the server CPU 14 functions as a determining unit (determiner) so as to determine priority of travelling order (order of travelling) regarding the plurality of automobiles 7 intending to travel on the road, in a step ST25 to a step ST27. Further, the sever CPU 14 changes the priority of travelling order used in generating of the travelling control information for the plurality of automobiles 7, by temporarily shelving the priority following the priority rule in traffic, if it is necessary to execute smooth travelling, depending on the determining result of the priority.

In the step ST25, the server CPU 14 determines whether or not a first automobile stopped at a position on a first road and just before a second road exists, a traffic jam existing in the second road, the first road extending toward a place where the first road and the second road are connected with each other by merging, crossing, etc., the second road having priority over the first road in the priority rule in traffic. A traffic jam exists on the second road. Further, the server CPU 14 may perform the determining of the step ST25, in a case that a traffic signal or gate does not exists at the place where the first and second roads merge or connect, or in a case that following automobiles 7 of a predetermined number or more exist behind the first automobile. In a case that there is the first automobile on the subordinate-side stopped at the position just before the second road in which the traffic jam exists, the server CPU 14 advances the process to a step ST29 in order to generate the travelling control information that temporarily gives priority to the first automobile on the subordinate-side regarding the travelling order. In a case that the stopped first automobile on the subordinate-side does not exist, the server CPU 14 advances the process to a step ST26.

In the step ST26, the server CPU 14 determines whether or not the first automobile travelling on a first lane is attempting to perform a lane change to a second lane on which a traffic jam exists, in a road having the first lane and the second lane adjacent to the first lane. Further, the server CPU 14 may perform the determining of step ST26, in a case that the first automobile has low speed or is stopped on the first lane or in a case that following automobiles 7 of a predetermined number or more exist behind the first automobile on the first lane. In a case that there is the first automobile attempting to perform the lane change to the second lane in which the traffic jam exists, the server CPU 14 advances the process to the step ST29, in order to generate the travelling control information that temporarily gives priority, regarding the travelling order, to the first automobile on the subordinate-side relative to the lane change. In a case that the first automobile attempting to perform the lane change does not exist, the server CPU 14 advances the process to the step ST27.

In the step ST27, the server CPU 14 determines whether or not a request from the first automobile stopped for traffic-jam-cutting-in exists. In a case that the first automobile attempts to perform the traffic-jam-cutting-in exists, the server CPU 14 advances the process to the step ST29, in order to generate the travelling control information that temporarily gives priority, regarding the travelling order, to the first automobile on the subordinate-side relative to the lane change. In a case that the first automobile attempting to perform the traffic-jam-cutting-in does not exist, the server CPU 14 advances the process to a step ST28 in order to generate the travelling control information following the priority rule in traffic.

In the step ST28, the server CPU 14 generates the travelling control information for the plurality of automobile 7 according to the priority following the priority rule in traffic.

In the step ST29, the server CPU 14 generates the travelling control information for the plurality of automobiles 7 such that the first automobile on the subordinate-side is temporarily given priority regarding the travelling order. The server CPU 14 generates the travelling control information for the plurality of automobiles 7 not following the priority based on the priority rule in traffic, such that the travelling of the first automobile has priority over the travelling of other automobile(s) even if the first automobile has lower priority (on the subordinate-side) compared to other automobile(s) based on the priority rule in traffic.

Next, specific examples of various travelling condition of the automobile 7 in the embodiment will be described.

### First Specific Example

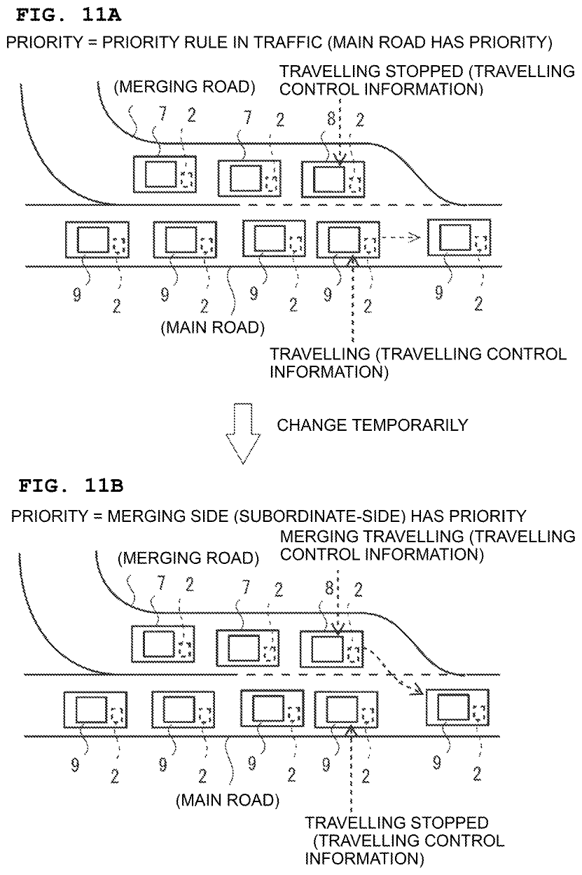

FIGS. 11A and 11B are explanatory diagrams of a first specific example of the travelling condition in which the first automobile 8 on the merging road travels toward the main road in which a traffic jam exists.

A merging section between the merging road and the main road is depicted in FIGS. 11A and 11B. On the main road, the plurality of second automobiles 9 travels is series due to the traffic jam. On the merging road, the plurality of automobiles 7 is stopped, and a second automobile 8 is the head.

Travelling control instructions to the first automobile 8 on the merging road and the second automobile 9 on the main road based on the priority rule in traffic are exemplified in FIG. 11A.

In the priority rule in traffic, the main lane has priority. The travelling of the second automobile 9 on the main road has priority over the travelling of the first automobile 8 on the merging road.

Thus, in the step ST28, the server CPU 14 generates the travelling control instructions for stopping the travelling, with respect to the first automobile 8 on the merging road. The server CPU 14 generates the travelling control instructions instructing continuation of the travelling, with respect to the second automobile 9 on the main road.

As a result, the plurality of automobiles 9 continues travelling while maintaining the traffic jam, on the main road. The first automobile 8 on the merging road is kept stopped on the merging road, and cannot travel smoothly.

The travelling control instructions to the first automobile 8 on the merging road being subordinate-side in the priority rule in traffic and the second automobile 9 on the main road are exemplified in FIG. 11B.

The first automobile 8 on the merging road is stopped on the merging road, and is not travelling smoothly.

Thus, in the step ST25, the server CPU 14 determines to temporarily give priority, regarding the travelling order, to the first automobile 8 on the subordinate-side stopped on the merging road, and in the step ST29, generate the travelling control instructions for restarting the travelling to execute the merging, with respect to the first automobile 8 on the merging road. The server CPU 14 generates the travelling control instructions to instruct decelerating or stopping of the travelling, with respect to the second automobile 9 on the main road.

As a result, the second automobile 9 in the traffic jam stops on the main road. The first automobile 8 on the merging road can travel such that the first automobile 8 merges into the main road and to a position prior to the second automobile 9 stopped, and merge into the array of automobiles on the main road at a position in front of the second automobile 9 decelerated or stopped.

### Second Specific Example

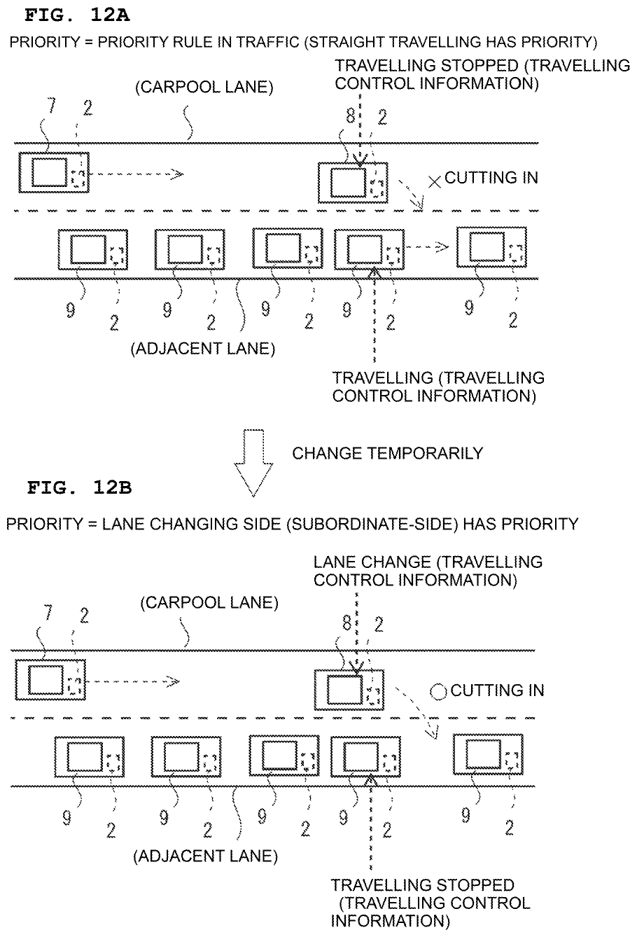

FIG. 12A and FIG. 12 B are explanatory diagrams of second specific examples of the travelling condition in which the first automobile 8 travelling on a carpool lane attempts to perform a lane change to an adjacent lane in which a traffic jam exists.

In FIG. 12A, a road having a carpool lane and an adjacent lane adjacent to the carpool lane is depicted. On the adjacent lane, the plurality of second automobile 9 travels in series due to a traffic jam. A first automobile 8 related to the lane change is stopped on the merging road. At a position behind the first automobile 8, other automobile 7 travels smoothly.

Travelling control instructions to the first automobile 8 on the carpool lane attempting to perform the lane change and the second automobile 9 travelling on the adjacent lane in which the traffic jam exists based on the priority rule in traffic are depicted in FIG. 12A.

Base on the priority rule in traffic, the straight travelling has priority in each lane. The travelling of the second automobile 9 travelling on the adjacent lane in which the traffic jam exists has priority over the travelling of the first automobile 8 attempting to perform lane change to the adjacent lane in which the traffic jam exists.

Thus, in the step ST28, the server CPU 14 generates the travelling control instructions for stopping the travelling, with respect to the first automobile 8 related to the lane change. The server CPU 14 generates the travelling control instructions instructing continuation of the travelling, with respect to the second automobile 9 travelling on the adjacent lane in which the traffic jam exists.

As a result, on the adjacent lane, the plurality of second automobiles 9 continues their travelling while maintaining the traffic jam. The first automobile 8 related to the lane change is kept stopped on the carpool lane, and cannot travel smoothly. Further, the other automobile 7 travelling behind the first automobile 8 on the carpool lane stops at a position behind the first automobile 8, and cannot continue travelling smoothly.

Travelling control instructions to a first automobile 8 related to the lane change that is subordinate-side based on the priority rule in traffic and the second automobile 9 travelling on the adjacent Jane are exemplified in FIG. 12B

The first automobile 8 related to the lane change is stopped on the carpool lane, and cannot travel smoothly.

Thus, in the step ST26, the server CPU 14 determines to temporarily give priority, regarding the travelling order, to the first automobile 8 on the subordinate-side related to the lane change, and in the step ST29, the server CPU 14 generates the travelling control instructions instructing stopping of the travelling, with respect to the second automobile 9 on the adjacent lane. The server CPU 14 generates the travelling control instructions for restarting the travelling and performing the lane change, with respect to the first automobile 8 related to the lane change.

As a result, the first automobile 8 related to the lane change can execute the travelling of the lane change such that the first automobile 8 cuts into a space in front of the second automobile 9 stopped. The first automobile 8 related to the lane change can travel such that the first automobile 8 cuts into a space between the plurality of automobile 9 travelling on the adjacent lane.

As described above, in the embodiment, the travelling control information for the plurality of automobiles 7 is generated in the server device 6 of the travelling control system 1 for the automobile 7, and is sent to the plurality of automobile 7. The plurality of automobiles 7 uses the travelling control information in the travelling control of the automatic driving or of the driving support in each of the plurality of automobiles. In such manner, by controlling basic travelling of the plurality of automobiles 7 by the travelling control system 1 for the automobile 7, the plurality of automobiles 7 can basically avoid or suppress a collision and can travel while ensuring high level of safety and a sense of security. Especially, the server device 6 generates the travelling control information for the plurality of automobiles 7, basically such that the plurality of automobiles 7 travels based on the priority following the priority rule in traffic, and thus the plurality of automobile 7 is less likely to give a sense of discomfort about their respective travelling to the occupants, and can realize smooth travelling following the priority rule in traffic.

Further, the travelling control system 1 for the automobiles 7 of the embodiment is configured to determine the priority among the plurality of automobiles 7 including the first automobile 8 intending to travel on the road, regarding the travelling order. Then, in a case that the server device 6 has determined to give priority to the first automobile 8 regarding the travelling order, the server device 6 generates the travelling control information not following the priority based on the priority rule in traffic for the plurality of automobiles 7, such that the travelling of the first automobile 8 has priority over the travelling of the other automobile 9 even if the first automobile 8 has lower priority (that is, the first automobile 8 is on a subordinate-side) based on the priority rule in traffic compared to other automobile 9. By doing so, in the embodiment, it is possible to give priority to the travelling of the first automobile 8 having lower priority based on the priority rule in traffic over the other automobile 9 by temporarily switching the priority regarding the travelling of the plurality of automobiles 7 based on determining result of the priority.

As described above, in the embodiment, it is possible to not only simply make it possible to avoid or suppress the collision, but also make it possible to obtain high level of safety and/or a sense of security regarding the travelling of the automobile 7, and further it is possible to realize smooth travelling of the plurality of automobiles 7.

By using the travelling control system 1 for the automobiles 7 of the embodiment, each automobile 7 executing the travelling control of the automatic driving or of the driving support can travel smoothly based on the priority following basically the priority rule in traffic.

Each automobile 7 can perform the travelling ensuring the high level of safety that cannot be obtained based simply on each automobile 7 performing travelling control autonomously and notifying it to other automobile 7 in the surroundings. The occupant is less likely to feel discomfort and/or anxiety about the travelling of the automobile 7.

The embodiments described above are examples of suitable embodiments of the present invention. However, the present invention is not limited to those embodiments, and various deformation and modification is possible within a range not deviating from gist of the invention.

In the embodiments described above, the determining of the priority is performed only in the server device 6.

Other than that, for example, the determining of the priority may be performed in the vehicle system 2 of each of the automobiles 7, or may be performed in both the server device 6 and the vehicle system 2 of each of the automobiles 7.

### REFERENCE SIGNS LIST

1: travelling control system
2: vehicle system
3: managing system
4: wireless base station
5: communication network
6: server device
7: automobile (vehicle)
8: first automobile
9: second automobile
11: server communication device
12: server GNSS receiver
13: server memory
14: server CPU
15: server bus
21: driving ECU
22: steering ECU
23: braking ECU
24: travelling control ECU
25: driving operation ECU
26: detecting ECU
27: AP communication ECU
28: communication ECU
30: automobile network
31: bus cable
32: central gateway
40: V2V communication apparatus
41: V2V communication device
42: V2V communication memory
51: steering wheel
52: brake pedal
53: accelerator pedal
54: shift lever
61: speed sensor
62: acceleration sensor
63: stereo camera
64: LIDAR
65: 360 degrees camera
66: GNSS receiver
70: AP communication apparatus
71: AP communication device
72: AP communication memory
79: control memory
80: current road map
81: horizontal axis
82 to 84: trajectory
85: decelerating stopping section
110: GNSS satellites

1. A travelling control system for vehicles comprising:
a plurality of vehicles each including a controller configured to execute travelling control of an automatic driving or of a driving support in a case that the plurality of vehicles travels on a road;
a server including a generator configured to generate travelling control information for each of the plurality of vehicles such that the plurality of vehicles travels based on priority following a priority rule in traffic; and
a determiner which is provided in the server and which is configured to determine priority with respect to the plurality of vehicles including a first vehicle intending to travel on the road, wherein:
the travelling control system is configured to send the respective travelling control information generated by the generator of the server for each of the plurality of vehicles to each of the plurality of vehicles so as to cause the controller of each of the plurality of vehicles to execute the travelling control using the respective travelling control information;
in a case that the determiner has determined to give priority to the first vehicle, the generator of the server is configured to generate the travelling control information for each of the plurality of vehicles such that a travelling of the first vehicle has priority over a travelling of other vehicle, of the plurality of vehicles, even in a case that the first vehicle has lower priority, based on the priority rule in traffic, compared to the other vehicle; and
the determiner is configured to determine to temporarily give priority to the first vehicle in a case that there is a request from the first vehicle stopped for performing traffic-jam-cutting-in.

2. (canceled)

3. The travelling control system for vehicles according to claim 1, wherein:
the determiner is configured to determine to temporarily give priority to the first vehicle on a subordinate-side, in a case that the first vehicle stops at a position, on a first road, before a second road in which a traffic jam exists, the first road extending to a place where the first road and the second road merge or connect with each other, the second road having higher priority, based on the priority rule in traffic, than the first road; and
the generator of the server is configured to generate the travelling control information for causing the first vehicle on the first road being the subordinate-side and having lower priority based on the priority rule in traffic to travel toward the place where the first road and the second road merge or connect with each other, prior to the other vehicle travelling toward the place where the first road and the second road merge or connect with each other on the second road having higher priority based on the priority rule in traffic.

4. The travelling control system for vehicles according to claim 1, wherein:
the determiner is configured to determine to give priority to the first vehicle on a subordinate-side, in a case that the first vehicle travelling on a first lane is attempting to perform a lane change to a second lane in which a traffic jam exists, on a road including the first lane and the second lane adjacent to the first lane; and
the generator of the server is configured to generate the travelling control information causing the first vehicle on the first lane related to the lane change being the subordinate-side and having lower priority based on the priority rule in traffic to travel so as to cut into a space between the plurality of vehicles travelling on the second lane having higher priority based on the priority rule in traffic.

5-6. (canceled)
